(19) United States
(12) Patent Application Publication
(10) Pub. No.: US 2008/0305025 A1
(43) Pub. Date: Dec. 11, 2008

(54) Methods for Production of Metal Oxide Nano Particles, and Nano Particles and Preparations Produced Thereby

(75) Inventors: Asher Vitner, Jerusalem (IL); Aharon Eyal, Jerusalem (IL)

Correspondence Address: LUCAS & MERCANTI, LLP, 475 PARK AVENUE SOUTH, 15TH FLOOR, NEW YORK, NY, 10016, US

(73) Assignee: Joma International AS, Solbakken (NO)

(21) Appl. No.: 12/096,154

(22) PCT Filed: Dec. 21, 2006
(86) PCT No.: PCT/IL2006/001469

§ 371 Date: Jun. 4, 2008

(30) Foreign Application Priority Data
Dec. 27, 2005 (IL) 172837

(51) Int. Cl. C01F 17/00; C01B 13/18; C01G 3/02; C01G 45/02; C01G 37/02; C01G 39/02; C01G 25/02; C01G 19/02; C01G 9/02; C01F 7/02; C01F 5/00; C01G 31/02; C01G 11/00; C01G 53/04; C01B 33/113; B01J 19/10; B01J 19/12; C01G 51/04

(52) U.S. Cl. 423/263; 423/592.1; 423/604; 423/605; 423/607; 423/606; 423/608; 423/618; 423/622; 423/625; 423/636; 423/594.17; 423/594.18; 423/594.19; 423/325; 204/157.42; 204/157.43

(57) ABSTRACT

The invention provides a method for the formation of small-size metal oxide particles, comprising the steps of: a) preparing a starting aqueous solution comprising at least one of metallic ion and complexes thereof, at a concentration of at least 0.1% w/w of the metal component; b) preparing a modifying aqueous solution having a temperature greater than 50° C.; c) contacting the modifying aqueous solution with the starting aqueous solution in a continuous mode in a mixing chamber to form a-modified system; d) removing the modified system from the mixing chamber in a plug-flow mode; wherein the method is characterized in that: i) the residence time in the mixing chamber is less than about 5 minutes; and iii) there are formed particles or aggregates thereof, wherein the majority of the particles formed are between about 2 nm and about 500 nm in size.

The present invention relates to a method for producing small size metal oxide particles and more particularly, to a method for producing metal oxide particles of desired particle size, particle size distribution and habit in an industrially and economically useful manner. In the present invention, the term metal oxide means and includes metal oxides of the formula MetalₓO_{y} (e.g. SnO, SnO₂, Al₂O₃, SiO₂, ZnO, CoO, Co₃O₄, Cu₂O, CuO, Ni₂O₃, NiO, MgO, Y₂O₃, VO, V0₂, V₂O₃, V₂O₅, MnO MnO₂, CdO, ZrO₂, PdO, PdO₂, MoO₃, MoO₂, Cr₂O₃, CrO₃, and RuO₂), metal hydroxy-oxides of the formula Metalₚ(OH)_{q}Oᵣ, (e.g. Sn(OH)₂, Sn(OH)₄, Al(OH)₃, Si(OH)₄, Zn(OH)₂, Co(OH)₂, Co(OH)₃, CuOH, Cu(OH)₂, Ni(OH)₃, Ni(OH)₂, Mg(OH)₂, Y(OH)₃, V(OH)₂, V(OH)₄, V(OH)₃, Mn(OH)₂ Mn(OH)₄, Cd(OH)₂, Zr(OH)₄, Pd(OH)₂, Pd(OH)₄, Mo(OH)₄, Cr(OH)₃, and Ru(OH)₄) metallic acid , various hydration forms thereof and compositions wherein these are major components, wherein x, y, p, q, r are each whole integers.

Metal oxides are used in a wide range of applications, such as for abrasives, catalysts, cosmetics, electronic devices, magnetics, pigments & coatings, and structural ceramics, etc.

Abrasives—The nanoparticles exhibit superior effectiveness in critical abrasive and polishing applications when properly dispersed. The ultra-fine particle size and distribution of properly dispersed products is virtually unmatched by any other commercially-available abrasives. The result is a significant reduction in the size of surface defects as compared to conventional abrasive materials. The metal oxide nanoparticles are mainly used as general abrasives, rigid memory disk polishing, chemical mechanical planarization (CMP) of semiconductors, silicon wafer polishing, optical polishing, fiber optic polishing, and jewelry polishing. The main used products are aluminum oxide, iron oxide, tin oxide, and chromium oxide.

Catalysts—The metal oxide nanoparticles possess enhanced catalytic abilities due to their highly stressed surface atoms which are very reactive. Thus, they are mainly used as general catalysts (e.g. titanium dioxide, zinc oxide, and palladium), oxidation reduction catalysts (e.g. iron oxide), hydrogen synthesis catalysts (e.g. iron oxide titanium dioxide), catalyst supports such as substrates for valuable metals (e.g. aluminum oxide, and titanium dioxide), catalysts for emission control, catalysts for oil refining, and waste management catalysts.

Cosmetics—The metal oxide nanoparticles facilitate the creation of superior cosmetic products. They provide high UV attenuation without the use of chemicals, provide transparency to visible light when desired, and can be evenly dispersed into a wide range of cosmetic vehicles to provide non-caking cosmetic products. The metal oxide nanoparticles are mainly used as sunscreens, moisturizers with SPF (sun protection foundation), color foundations with SPF, lipstick with SPF, lip balm with SPF, foot care products, and ointments. The main products for cosmetic applications are zinc oxide powder, ZnO dispersions, FE45B (brown iron oxide), TiO₂ dispersions, black metal-oxide pigment, red metal-oxide pigment, metal-yellow oxide pigment, and metal-blue oxide pigment.

Electronic Devices—The metal oxide nanoparticles can provide new and unique electrical and conduction properties for use in existing and future technologies. The metal oxide nanoparticles are mainly used as varistors (e.g. zinc oxide), transparent conductors (indium tin oxide), high dielectric ceramics, conductive pastes, capacitors (titanium dioxide), phosphors for CRT displays (e.g. zinc oxide), electroluminescent panel displays (e.g. zinc oxide), ceramic substances for electronic circuits (e.g. aluminum oxide), automobile air bag propellant (e.g. iron oxide), phosphors inside fluorescent tubes (e.g. zinc oxide), and reflectors for incandescent lamps (e.g. titanium dioxide).

Magnetics—The metal oxide nanoparticles can provide new and unique magnetic properties for use in existing and future technologies. The metal oxide nano particles are mainly used as ferrofluids and magnetorheological (MR) fluids.

Pigments & Coatings—The metal oxide nanoparticles facilitate the creation of superior pigments and coatings. They provide high UV attenuation, transparency to visible light when desired, and can be evenly dispersed into a wide range of materials. The nanoparticles can also provide more vivid colors that will resist deterioration and fading over time. The metal oxide nano-particles are mainly used as general pigments & coatings, microwave absorbing coatings, radar absorbing coatings, UV protecting clear coatings, antifungicide for paints, powder coatings, and automotive pigments (demisted on mica for metallic look).

Structural Ceramics—The metal oxide nanoparticles can be used in the production of ceramic parts. The ultra-fine size of the particles allows near-net shaping of ceramic parts via super plastic deformation, which can reduce production costs by reducing the need for costly post-forming machining. The metal oxides are mainly used as translucent ceramics for Arc-tube envelopes, reinforcements for metal-matrix composites, porous membranes for gas filtration, and net shaped wear resistant parts.

A lot of important nano-metal oxides powders have not yet been commercialized. The reported processes used to achieve nano-metal oxides are very expensive, have low yields and, most importantly, production scale up can be difficult.

Following are several methods described in the prior art for synthesizing metal oxide nanoparticles.

Gas-Phase Synthesis—A number of methods exist for the synthesis of nano-particles in the gas phase. These include gas condensation processing, chemical vapor condensation, microwave plasma processing and combustion flame synthesis. In these methods the starting materials are vaporized using energy sources such as Joule heated refractory crucibles, electron beam evaporation devices, sputtering sources, hot wall reactors, etc. Nano-sized clusters are then condensed from the vapor in the vicinity of the source by homogenous nucleation. The clusters are subsequently collected using a mechanical filter or a cold finger. These methods produce small amounts of non-agglomerated material, with a few tens of gram/hour quoted as a significant achievement in production rate.

Mechanical Attrition or Ball Milling—This method is a method that can be used to produce nano-crystalline materials by the structural decomposition of coarser-grained materials as a result of severe plastic deformation. The quality of the final product is a function of the milling energy, time and temperature. To achieve grain sizes of a few nanometers in diameter requires relatively long processing times or several hours for small batches. Another main drawback of this method is that the milled material is prone to severe contamination from the milling media.

Sol-Gel Precipitation-Based Synthesis—Particles or gels are formed by hydrolysis-condensation reactions, which involve first hydrolysis of a precursor, followed by polymerization of these hydrolyzed percursors into particles. By controlling the hydrolysis-condensation reactions, particles with very uniform size distributions can be precipitated. The disadvantages of sol-gel methods are that the precursors can be expensive, careful control of the hydrolysis-condensation reactions is required, and the reactions can be slow.

Methods based on Microemulsion—Microemulsion methods create nanometer-sized particles by confining inorganic reactions to nanometer-sized aqueous domains that exist within an oil. These domains, called water-in-oil or inverse microemulsions, can be created using certain surfactant/water/oil combinations. Nanometer-sized particles can be made by preparing two different inverse microemulsions that are mixed together, causing them to react with each other and thereby form particles. The drawback of this method is that it produces small reaction volumes, thereby resulting in low production volumes, low yields, and an expensive process.

Surfactant/Foam Framework—In this process (as presented in U.S. Pat. No. 5,338,834 and U.S. Pat. No. 5,093,289) an ordered array of surfactant molecules is used to provide a “template” for the formation of the inorganic material. The surfactant molecules form a framework and deposit inorganic material onto or around the surfactant structures. The surfactant is then removed (commonly by burning out or dissolution) to leave a porous network that mimics the original surfactant structure. Since the diameter of the surfactant micelles can be extremely small, the pore sizes that can be created using the method are also extremely small, which leads to very high surface areas in the final product.

Precipitation—It is possible, in some special cases, to produce nano-crystalline materials by precipitation or co-precipitation if reaction conditions and post-treatment conditions are carefully controlled. Precipitation reactions are among the most common and efficient types of chemical reactions used to produce inorganic materials at industrial scales. In a precipitation reaction, typically, two homogenous solutions are mixed and an insoluble substance (a solid) is subsequently formed. Conventionally, one solution is injected into a tank of the modifying solution in order to induce precipitation. However, the control of this method is complicated and therefore properties, such as uniform distribution of particle size and a specific particle size in the nano-scale, are hard to achieve.

The main objective of the present invention is to provide an industrial and economical process for producing nano-scale metal oxide particles of desired properties, e.g., uniform distribution of particle size, a specific particle size which may be changed according to customer demands, and nano-particles of a required crystal habit and structure.

Another objective of the present invention is to use precipitation for the production of nano-scale metal oxide particles, since this method is characterized by the most desirable properties, from the industrial point of view, of being a simple and inexpensive process. However, a further objective of the present invention is to make changes to the traditional process of producing nano-scale metal oxide particles, which will enable the controlling of the system and thereby achieve the strict demands of the market.

Still another objective of the present invention is to provide an industrial and economical process for the production of nano-scale metal oxide particles characterized by a low hydration level.

With this state of the art in mind, there is now provided, according to the present invention, a method for the formation of small-size metal oxide particles, comprising the steps of:
a) preparing a starting aqueous solution comprising at least one of metallic ion and complexes thereof, at a concentration of at least 0.1% w/w of such metal,
b) preparing a modifying aqueous solution at a temperature greater than 50° C.;
c) Adjusting the conditions by contacting the modifying solution with the starting aqueous solution in a continuous mode in a mixing chamber to form a modified system;
d) removing the modified system from the mixing chamber in a plug-flow mode, and
   which method is characterized in that:
i. the residence time in the mixing chamber is less than about 5 minutes, and
ii. there are formed particles or aggregates thereof,
   wherein the majority of the particles formed are between about 2 nm and about 500 nm in size.

The term metal, as used in the present specification, refers to a metal selected from the group consisting of tin, aluminum, silicon, zinc, cobalt, copper, nickel, magnesium, yttrium, vanadium, manganese, cadmium, zirconium, palladium, molybdenum, chromium ruthenium and a combination thereof.

The term metal oxide, as used in the present specification, preferably refers to a metal oxide selected from the group consisting of metal oxides of the formula MetalₓO_{y}, metal hydroxy-oxides of the formula Metalₚ(OH)_{q}Oᵣ metallic acid, various hydration forms of those and compositions wherein these are major components, wherein x, y, p, q, r are each whole integers.

In preferred embodiments of the present invention said metal oxides of the formula MetalₓO_{y} are selected from the group consisting of SnO, SnO₂, Al₂O₃, SiO₂, ZnO, CoO, Co₃O₄, Cu₂O, CuO, Ni₂O₃, NiO, MgO, Y₂O₃, VO, VO₂, V₂O₃, V₂O₅, MnO MnO₂, CdO, ZrO₂, PdO, PdO₂, MoO₃, MoO₂, Cr₂O₃, CrO₃, and RuO₂.

In preferred embodiments of the present invention said metal hydroxy-oxide of the formula Metalₚ(OH)_{q}Oᵣ is Sn(OH)₂, Sn(OH)₄, Al(OH)₃, Si(OH)₄, Zn(OH)₂, Co(OH)₂, Co(OH)₃, CuOH, Cu(OH)₂, Ni(OH)₃, Ni(OH)₂, Mg(OH)₂, Y(OH)₃, V(OH)₂, V(OH)₄, V(OH)₃, Mn(OH)₂ Mn(OH)₄, Cd(OH)₂, Zr(OH)₄, Pd(OH)₂, Pd(OH)₄, Mo(OH)₄, Cr(OH)₃, and Ru(OH)₄.

In a second aspect of the present invention, there is provided raw material for producing other metal oxide particles by conventional methods such as heat-transformation of the obtained particles, calcination or ripening.

In preferred embodiments of the present invention said adjusting conditions are conducted by at least one of the steps of: heating said starting aqueous solution by at least 10° C., elevating the pH of said starting aqueous solution by at least 0.2 units and diluting the starting aqueous solution by at least 20% or combinations thereof, whereas said modified system is maintained at said adjusting conditions for at least 0.5 minutes.

In preferred embodiments of the present invention said solution is kept at said modified conditions for at least 0.5 minutes.

Preferably said modification of conditions is carried out over a period of up to 2 hours.

In preferred embodiments of the present invention, said process produces at least 50 kilograms of particles per hour.

Preferably said modification of conditions is carried out at a pressure of up to 100 atmospheres.

In preferred embodiments of the present invention said method is further characterized in that the majority of the formed particles have a degree of crystallinity of more than 50%.

Preferably said method is further characterized in that the size ratio between the smallest and largest particles of the mean 50% (by weight) of the formed particles is less than about 10, in especially preferred embodiments it is less than about 5.

The term mean 50% by weight as used in the present specification refers to the 50% by weight of the particles that include 25% by weight of the particles which are larger than the mean size of the particles and 25% of the particles which are smaller than the mean size of the particles. Said larger 25% and said smaller 25% of the particles are those that are closest in size to the mean size in a standard statistical diagram representing the size distribution of the formed particles.

Preferably said method is further characterized in that the majority of the formed particles are of a configuration other than elongated.

In preferred embodiments of the present invention said method is further characterized in that the majority of the formed particles have a configuration wherein the ratio between one dimension and any other dimension is less than about 3.

In other preferred embodiments of the present invention the majority of the formed particles are of an elongated configuration.

Preferably the majority of the formed particles have a surface area of at least 30 m²/gr.

Preferably the majority of the formed particles have a surface area of at least 100 m²/gr.

In especially preferred embodiments of the present invention said method further comprises the step of calcination, i.e. heating said formed particles to a temperature in a range of between about 90° C. and about 900° C. to form dehydrated particles.

In said preferred embodiments, said method preferably further comprises the step of removing part of the water in said particles which are in a suspension form after said modification step and prior to, simultaneously with or after said dehydrating.

In said preferred embodiments said dehydrating is preferably conducted under super-atmospheric pressure.

In said preferred embodiments the temperature of said particles which are in a suspension form, is preferably elevated to said dehydrating temperature over a period of up to 4 hours.

In said especially preferred embodiments the majority of the dehydrated particles are preferably of a configuration other than elongated.

In said especially preferred embodiments the majority of the dehydrated particles preferably have a surface area of at least 30 m²/gr.

In preferred embodiments of the present invention said preparation of a starting aqueous solution involves dissolution of a metal compound, addition of a base to the metal salt solution and acidulation of a metal salt solution.

In said preferred embodiments said metal compound is preferably selected from the group consisting of metal salts, metal oxides, metal hydroxides, metal minerals and combinations thereof. In the present invention the term metal complexes includes metal salts, metal complexes and metal hydroxides

Preferably said metal compound is selected from the group consisting of metal oxides, metal hydroxides, minerals containing said metals and mixtures thereof and said compound is dissolved in an acidic solution comprising an acid selected from the group consisting of sulfuric acid, nitric acid, hydrochloric acid, phosphoric acid, their acidic salts and combinations thereof.

In preferred embodiments of the present invention said prepared starting aqueous solution comprises an anion selected from the group consisting of sulfate, chloride, nitrate, phosphate, an organic acid and mixtures thereof.

In preferred embodiments of the present invention said modification comprises at least two heating steps.

In said preferred modification step at least one heating step is preferably conducted by contacting with a warmer stream selected from a group consisting of hot aqueous solutions, hot gases and steam.

In preferred embodiments said method preferably further comprises grinding formed particles.

In preferred embodiments said method preferably further comprises screening formed particles.

The present invention is also directed to metal oxide particles whenever formed according to the above-defined methods and products of their conversion.

The present invention is further directed to a preparation comprising said particles.

In preferred embodiments of said preparation said particles are preferably dispersed in a liquid, supported on a solid compound or agglomerated to larger particles.

In another aspect of the present invention there is provided a process for the production of a preparation as defined above comprising steps selected from the group consisting of dispersing said particles, addition of a support, heat treatment, mixing, water evaporation spray drying, thermal spraying and combinations thereof.

In especially preferred embodiments of the present invention said particles and preparations are used in the manufacture of paint.

In especially preferred embodiments of the present invention the modified system stays in said mixing chamber for less than 5 seconds and in a more preferred embodiment the modified system stays in said mixing chamber for less than 0.5 seconds.

In preferred embodiments of the present invention, the mixing in the mixing chamber is carried out using the flow rate of the entering solution, by using a mechanical mode of mixing or another mode of mixing.

In preferred embodiments of the present invention the modified system exits the mixing chamber in a plug flow mode. In a more preferred embodiment the plug flow continues for more then 0.1 seconds and in a most preferred embodiment the plug flow continues for more then 5 seconds.

In preferred embodiments of the present invention the solution exiting the plug flow enters into a vessel. In a more preferred embodiment of the present invention the solution in the vessel is mixed.

### DETAILED DESCRIPTION OF THE INVENTION

The present invention will now be described in detail below.

The starting aqueous metal salt solution used in the present invention, is preferably an aqueous metal salt solution comprising metallic ions or their complexes at a concentration of at least 0.1% w/w metal.

According to a preferred embodiment, the metal w/w concentration in the starting solution (or the metallic salt solution) is at least 2%, more preferably at least 5%, most preferably at least 10%. There is no upper limit to the concentration of the starting solution. Yet, according to a preferred embodiment, the concentration is below the saturation level. According to another preferred embodiment high viscosity is not desired. According to yet another preferred embodiment, OH/metal ratio in the solution is less than 2. According to a preferred embodiment, the temperature of the prepared starting solution is less than 70° C.

Any source of metal is suitable for preparing the starting solution of the present invention, including metal containing ores, fractions of such ores, products of their processing, metal salts or metal containing solutions such as aqueous solution exiting metal containing ores.

According to a preferred embodiment the preparation time of the starting solution is shorter than 20 hours, preferably shorter than 10 hours, most preferably shorter than 2 hours. In cases wherein an older solution exists (e.g. a recycled solution) and is to be mixed with a fresh solution to form the starting solution, the older solution is first acid treated, as described hereinafter.

The freshly prepared metallic salt solution may contain any anion, including chloride, sulfate, nitrate phosphate, carboxylate, organic acid anions, and various mixtures thereof. According to a preferred embodiment, the freshly prepared solution comprises metallic sulfate. According to another preferred embodiment, the salt is of an organic acid.

A freshly prepared salt solution for use in the process of the present invention may be a solution that was produced (in natural conditions, such as solutions exiting mines with metal containing ores) or a solution that was prepared by artificial methods including chemical or biological oxidations. Such a solution could be prepared by various methods or their combinations, including dissolution of metallic salts, dissolution of double salts, dissolution of metal oxide-containing ores in an acidic solution, dissolution of scrap metal in oxidizing solutions, such as solutions of metallic salt, nitric acid, etc., and leaching of metal-containing minerals.

Preparation of the aqueous solution is conducted in a single step, according to a preferred embodiment. According to an alternative embodiment, the preparation comprises two or more steps. According to another embodiment, a concentrated solution of metallic salt is prepared, e.g. by dissolution of a salt in water or in an aqueous solution. While momentarily and/or locally, during the dissolution, the required pH and concentration of the starting solution are reached, typically the pH of the formed concentrated solution after at least partial homogenization, is lower than desired for the starting solution. According to a preferred embodiment, such momentary reaching the desired conditions is not considered preparation of the starting solution. The pH of the concentrated solution is then brought to the desired level by any suitable means, such as removal of an acid, addition and/or increasing the concentration of a basic compound, or a combination of these. The formation of the starting solution in that case is considered the adjustment of the pH to the selected range, according to a preferred embodiment, and the pH of the starting solution is the one obtained after at least partial homogenization, according to another preferred embodiment. According to still another preferred embodiment, a concentrated solution is prepared and the pH is adjusted to a level that is somewhat lower than desired. The starting solution is then prepared by dilution of the solution, which increases the pH to the desired level. Here again, the pH of the starting solution is the one obtained after at least partial homogenization, according to a preferred embodiment. The same is true for other methods of multi-stage preparation of the starting solution, as e.g. in the case of forming a solution of a metallic salt.

According to a preferred embodiment, the starting solution is freshly prepared. According to another preferred embodiment, the solution does not comprise ions and/or complexes prepared at different times, as in the case of mixing a recycled solution with a freshly prepared one.

At a pH lower than the pKa of the metal, high concentration (e.g. above 10% metal) and low temperatures (e.g. lower than 40° C.), a solution maintains its freshness for a longer time, and could serve as a stock solution in yet another preferred embodiment of the present invention.

The term pKa of the metal as used in the present invention refers to the logarithmic value of the hydrolysis constant of the metal, Ka, in relation to the following reaction:

M^{x}+H₂O [symbol] [symbol] (MOH)^{x-1}+H⁺;

while

Ka=[(MOH)^{X-1}]*[H⁺]/[M^{x}]*[H₂O];

wherein, M refers to the metal and X or X-1 to the valiancy.

At other conditions, the solution is not considered fresh after a few hours or a few days.

According to a preferred embodiment, freshness of the solution is regained by acid treatment. Such less fresh solution is acidulated to a pH lower than the value of (pKa-1.5) and preferably to a pH lower than (pKa-2) and is preferably mixed, agitated or shaken for at least 5 min, before increasing the pH back to the initial value to reform a fresh solution. Such reformed fresh solution is mixed with other fresh solution according to a preferred embodiment.

In the next step of the process, the metallic solution is preferably retained at a temperature lower than 70° C. for a retention time that doesn't exceed 14 days. During the retention time, hydrolysis takes place. According to a preferred embodiment, the retention time is the time needed to produce at least 0.1 millimol H⁺ (protons) in solution per one millimol of metal. According to still another preferred embodiment, in cases wherein a base or a basic compound is added to the solution during the retention time, the retention time is the time that would have been needed to form these amounts of protons with no base addition.

According to a preferred embodiment, the starting solution is retained for a retention time which decreases with increasing pH of the prepared solution. Thus, e.g. at a pH lower than pKa_{(of the metal)}, the retention time is preferably from 20 min to few days. At a pH of between the values of (pKa+1) to (pKa+4) the retention time is preferably less than 1 day. In cases of varying pH during the retention time, the latter is affected by the maximal pH reached. Typically, retention time decreases with increasing temperature of the solution.

Step (c) needed in order to achieve the above mode of precipitation, is modifying or adjusting the conditions of the solution in order to achieve at least one of an increase in pH and/or temperature and/or dilution of the solution.

The modification of conditions is preferably done in a short time span and the modified conditions are maintained for a short time. The duration of the modified conditions is less than 24 hours, according to an exemplary embodiment, preferably less than 4 hours, more preferably less than 2 hour, and most preferably less than 10 minutes. In other preferred embodiments of the present invention, the modification of conditions is conducted within 2 hours, preferably within 10 minutes, and more preferably within 1 minute.

Increasing the pH in the modification stage can be achieved by any known method, such as removal of an acid, or addition of or increasing the concentration of a basic compound. Acid removal can be conducted by known methods, such as extraction or distillation. Any basic compound could be added. According to a preferred embodiment, a basic compound is a compound that is more basic than the metallic sulfate, as measured by comparing the pH of their equi-molar solutions. Thus, such basic compound, is preferably at least one of an inorganic or organic base or precursor of a base, e.g. an oxide, hydroxide, carbonate, bicarbonate, ammonia, urea, etc. Such methods of increasing pH are also suitable for use in step (a) of preparing the starting solution. According to a preferred embodiment, basic pH is avoided through most of the process, so that the pH increase in step (c) is conducted so that during most of the duration of that step, the pH is acidic, or slightly acidic.

According to another preferred embodiment the pH in step (a) is decreased by the addition of an acid. According to a preferred embodiment the anion of the acid is the same anion present in the metal salt but other anions can also be used.

According to another preferred embodiment, the solution is diluted in step (c). According to a preferred embodiment, dilution is by at least 20%, more preferably at least 100%, and most preferably at least 200%.

According to another preferred embodiment, the temperature of the solution is increased. According to yet another preferred embodiment, temperature is increased by at least 10° C., more preferably by at least 30° C., yet more preferably at least 50° C., and most preferably by at least 80° C. Temperature increase can be affected by any known method, such as contact with a hot surface, hot liquid, hot vapors, infra-red irradiation, microwaving or any combination thereof.

According to another preferred embodiment two or all three of the modifications are conducted sequentially or simultaneously. Thus, according to a preferred embodiment, the basic compound is added to the solution of the metallic salt (the starting solution), in said modifying aqueous solution, which also dilutes the metallic salt. According to another preferred embodiment, the solution of the metallic salt is contacted with a modifying solution comprising water and/or an aqueous solution, which is of a temperature greater than the solution of the metallic salt solution by at least 50° C. according to a first preferred embodiment, and preferably by at least 100° C. According to an alternative embodiment, the temperature of said diluting solution is between about 100° C. and 250° C., and between 150° C. and 250° C. according to another preferred embodiment. According to yet another preferred embodiment, said modifying solution comprises a reagent that interacts with metallic ions, their complexes and/or with particles thereof.

According to still another preferred embodiment, the metallic salt solution after a retention time is combined in step (c) with said modifying aqueous solution, comprising a solute that is more basic than the metallic salt, and which modifying solution is at a temperature greater than the solution of the metallic salt. According to a preferred embodiment, the metallic salt solution and said modifying solution are mixed, e.g. mechanically, in suitable equipment that provides for strong mixing in order to rapidly achieve a homogenous system. In cases where the temperature of at least one of these solutions is above boiling point, the mixing equipment is preferably selected so that it withstands super-atmospheric pressure. According to a preferred embodiment, the mixing is conducted by contacting flowing metallic salt solution with flowing modifying aqueous solution, e.g. in a plug-flow mode. Preferably, the mixed stream is kept at the formed temperature or at another temperature obtained by cooling or heating for a short duration, less than 1 day according to an exemplary embodiment, preferably between 1 and 60 minutes, more preferably between 0.5 and 15 minutes.

The temperature of the modified system is determined by the temperatures of the starting solution and of the hot modifying solution, by their heat capacity and by their relative amounts. According to a preferred embodiment, the temperature of the modified system is kept with minimal changes, e.g. with no changes greater than 20° C. According to a preferred embodiment the modified system is retained at that temperature for a duration of between 1 and 30 minutes, more preferably between 3 and 15 minutes.

A modifying aqueous solution of a temperature greater than 80° C. and the starting solution are contacted in a continuous mode in a mixing chamber to form a modified system. The mixing chamber is built in a way to ensure quick and efficient mixing of the solutions. The modified system is removed from the mixing chamber in a plug-flow mode. During the plug flow the precipitation is completed, or in another preferred embodiment the solution is not exhausted during the plug flow time and the precipitation continues in another vessel.

The mixing in the mixing chamber is preferably carried out using the flow rate of the entering solution, or by using mechanical mixing means or another mode of mixing.

In one preferred embodiment, the temperature in the mixing chamber and during the plug flow are similar. In another preferred embodiment the temperature of the solution during the plug flow is higher than in the mixing chamber and in yet another preferred embodiment the temperature of the solution during the plug flow is lower than in the mixing chamber.

In a preferred embodiment of the present invention a solution containing a compound selected from the group consisting of an acid and a base is added to at least one of the solutions selected from the group consisting of said starting solution, modifying solution and modified system.

In a preferred embodiment of the present invention, the residence time in a mixing chamber is less than about 5 minutes and more preferred is a residence time of less than 1 minute. In an even more preferred embodiment, the residence time in a mixing chamber is less than about 5 seconds and in an especially preferred embodiment the residence time is less than 0.5 seconds.

In preferred embodiments of the present invention the solution exiting the plug flow enters into a vessel. In a more preferred embodiment of the present invention the solution in the vessel is mixed.

The degree of heating, pH elevation and dilution, when conducted as a single means for modification or in combination, affects the chemical nature of the formed particles. For example, typically, the higher the temperature, the lower is the degree of hydration of the particle components. The crystal form and shape are also affected.

According to a preferred embodiment, the final product oxide is formed in step (c) of the process. According to another preferred embodiment, the product of step (c) is further processed and transformed into the desired final product.

Such further processing comprises heating and/or partial or full removal of water, according to a preferred embodiment. Preferably heating is to a temperature in the range of between about 90° C. and 900° C. According to another preferred embodiment, the formed particles are first separated from the solution. The separated particles could be treated as such or after further treatment, e.g. washing and/or drying. Heating the solution is preferably done at a super-atmospheric pressure and in equipment suitable for such pressure. According to a preferred embodiment, an external pressure is applied. The nature of heating is also a controlling factor, so that the result of gradual heating is in some cases different from that of rapid heating. According to a preferred embodiment, step (c) and further heating are conducted sequentially, preferably in the same vessel.

According to a preferred embodiment the crystal habit of the transformed particles is of the general habit of the origin particles from which it was produced. For example rod-like particles can be transformed to elongated particles.

In another embodiment of the present invention amorphous metallic acid particles with low particle dimension ratio can be transformed to particles with a high dimension ratio.

In another embodiment of the present invention, agglomerates with rod-like habit or agglomerates of spherical habit can be transformed into particles with rod-like habit or agglomerates with spherical habit, respectively.

As will be realized the present invention provides conditions for the production of precipitates which are easy to transform as well as providing a transformation product with superior properties.

According to a preferred embodiment, at least one dispersant is present in at least one of the method steps. As used here, the term dispersant means and includes dispersants, surfactants, polymers and rheological agents. Thus, a dispersant is introduced into a solution in which a metallic salt is dissolved or is to be dissolved, or is added to a precursor of the solution, such as a mineral ore, according to a preferred embodiment. According to another preferred embodiment, a dispersant is added to the solution during the retention time or after it. According to an alternative embodiment, a dispersant is added to the solution prior to the adjustment step or after such step. According to still another preferred embodiment, a dispersant is added prior to a transforming step, during such step or after it. According to another preferred embodiment, the process further comprises a step of changing the concentration and/or the nature of the dispersant during the process and/or another dispersant is added. According to a preferred embodiment, suitable dispersants are compounds having the ability to adsorb on the surface of nanoparticles and/or nuclei. Suitable dispersants include cationic polymers, anionic polymers, nonionic polymers, surfactants poly-ions and their mixtures. In the present specification the term “dispersant” relates to molecules capable of stabilizing dispersions of the formed particles, and/or modifying the mechanism of formation of the nanoparticles, and/or modifying the structure, properties and size of any species formed during the process of formation of the nanoparticles.

According to a preferred embodiment, said dispersant is selected from a group consisting of polydiallyl dimethyl ammonium chloride, sodium-carboxy methyl cellulose, poly acrylic acid salts, polyethylene glycol, and commercial dispersants such as Solsperse® grade, Efka® grades, Disperbyk® or Byk® grade, Daxad® grades and Tamol® grades.

According to a preferred embodiment, the process further comprises, during or after at least one of the process steps, a step of ultrasound treating of the solution.

According to a preferred embodiment, the process further comprises a step of microwave treating of the solution during or after at least one of the process steps.

According to a preferred embodiment, further processing comprises partially fusing particles to particles of greater size. According to another preferred embodiment, aggregates of the particles are mechanically treated for comminuting.

The product of the present invention, as formed in step (c) or after further transformation, is preferably small-size particles of metal oxide. The particle size is in the range between 2 nm and 500 nm, according to a preferred embodiment. According to another preferred embodiment, the size distribution of the product particles is narrow so that the size ratio between the smallest and biggest particle of the mean 50% (by weight) of the formed particles is less than about 10, more preferably less than 5, most preferably less than 3.

Separate particles are formed according to a preferred embodiment. According to another embodiment, the formed particles are at least partially agglomerated.

According to a preferred embodiment, the majority of the formed particles have a degree of crystallinity of more than 50% as determined by X-ray analysis.

According to a preferred embodiment, the shape of the particles formed in step (c) or after further transformation, is elongated, such as in needles, rods or rafts.

According to another preferred embodiment, the particles are spherical or nearly spherical, so that the majority of the formed particles have a configuration wherein the ratio between one dimension and any other dimension is less than about 3.

According to a preferred embodiment, the majority of the formed particles have a surface area of at least 30 m²/gr, more preferably at least 100 m²/gr. High surface area particles of the present invention are suitable for use in catalyst preparation.

The process of the present invention is capable of forming highly pure metal oxide from a precursor of relatively low purity, such as a metal ore. According to a preferred embodiment, the purity with regards to other metals intermixed therewith is of at least 95%, more preferably at least 99%.

According to another preferred embodiment, the metal oxide particles are doped with ions or atoms of other transition metals.

According to a preferred embodiment, the particles are obtained in a form selected from a group consisting of particles dispersed in a liquid, particles supported on a solid compound, particles agglomerated to larger particles, partially fused particles, coated particles, or a combination thereof.

The particles, their preparation and/or products of their conversion are suitable for use in many industrial applications, such as in production of pigments, catalysts, coatings, thermal coating, etc. The particles are used in these and other applications as such according to a preferred embodiment, further processed according to another embodiment, or formed as part of preparing material for such application, according to still another preferred embodiment.

Many of the processes described in the literature are suited for use in laboratories, and are not highly practical for commercial use. They start with a highly pure precursor, work with a highly dilute solution, and/or are at a low volume and rate. The method of the present invention is highly suitable for economically attractive industrial scale production. According to a preferred embodiment, the method is operated at a production rate of at least 50 Kg/hour, more preferably at least 500 Kg/hour.

According to a preferred embodiment the pH of the solution drops during the process due to the hydrolysis of the metallic salt and thereby formation of an acid, e.g. sulfuric acid, is achieved. Such acid is reused according to a preferred embodiment, e.g. for the formation of the metallic salt solution, e.g. in dissolution of a metal-containing mineral according to another preferred embodiment. The formed acid is partially or fully neutralized during the process, forming thereby a salt of the acid. According to a preferred embodiment, the salt is of industrial use, e.g. as in the case where neutralization is done with ammonia to form ammonium salts suitable for use as fertilizers.

It will be evident to those skilled in the art that the invention is not limited to the details of the foregoing description and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1-57. (canceled)

58. A method for the formation of small-size metal oxide particles, comprising the steps of:
a) preparing a starting aqueous solution comprising at least one of metallic ion and complexes thereof, at a concentration of at least 0.1% w/w of said metal component;
b) preparing a modifying aqueous solution having a temperature greater than 50° C.;
c) contacting the modifying aqueous solution with the starting aqueous solution in a continuous mode in a mixing chamber to form a modified system;
d) removing the modified system from the mixing chamber in a plug-flow mode; wherein said method is characterized in that:
i) the residence time in the mixing chamber is less than about 5 minutes; and
ii) there are formed particles or aggregates thereof, wherein the majority of the particles formed are between about 2 nm and about 500 nm in size and optionally further calcining said formed particles at a temperature in a range between about 90° C. and about 900° C. to form dehydrated particles

59. A method according to claim 58, wherein the conditions in said system are adjusted by at least one of the steps of:
a) heating said starting aqueous solution by at least 10° C.,
b) elevating the pH of said starting aqueous solution by at least 0.2 units; and
c) diluting the starting aqueous solution by at least 20% or a combination thereof wherein said modified system is maintained at said adjusting conditions for at least 0.5 minutes.

60. A method according to claim 59, wherein said adjustment of conditions is carried out for a period of less than 2 hours.

61. A method according to claim 58, further characterized in that the majority of the formed particles have a degree of crystallinity of more than 50%.

62. A method according to claim 58, further characterized in that the size ratio between the smallest and largest particle of the mean 50% by weigh of the formed particles is less than about 10

63. A method according to claim 58, wherein said dehydrating step and said adjusting step are conducted simultaneously and wherein adjusting involves heating to the temperature of the calcination.

64. A method according to claim 58, wherein said metal is selected from the group consisting of tin, aluminum, silicon, zinc, cobalt, copper, nickel, magnesium, yttrium, vanadium, manganese, cadmium, zirconium, palladium, molybdenum, chromium ruthenium and a combination thereof and , wherein said metal oxide is selected from the group consisting of metal oxides of the formula MetalₓO_{y}, metal hydroxy-oxides of the formula Metalₚ(OH)_{q}Oᵣ, metallic acid, various hydration forms of those and compositions wherein those are major components, wherein x, y, p, q, r are each whole integers.

65. A method according to claim 58, wherein the metal concentration in the prepared solution is greater than about 5 wt %

66. A method according to claim 58, wherein said starting solution is treated by at least one of the following operations: a) ultrasound, and b) microwaving.

67. Metal oxide particles whenever formed according to the method of claim 58, products of their conversion and preparations comprising them.

68. The metal oxide particles of claim 67, characterized in at least one of
i. that the purity of the metal oxide particles with regard to other metals intermixed therewith is of at least 95%; and
ii. that said particles are doped with atoms of other compounds.

69. A preparation according to claim 67, wherein said particles are dispersed in a liquid, supported on a solid compound, agglomerated to larger particles, partially fused, coated or any combination thereof.

70. A method comprising using at least one of said particles and said preparations according to claim 67 as at least one of a pigment, a catalyst and a coating.

71. Industrial production of particles according to claim 58, wherein particles are formed at a rate of at least 50 Kg/hour.

72. A method according to claim 58, wherein the temperature of the modifying solution is in the range between 100° C. and 300° C.

73. A method according to claim 58, wherein the modified system is retained for a duration of between 1 and 30 minutes and wherein during said retaining the temperature is maintained within less than a 20° C. change in either direction from the temperature of the modified system.

74. A method according to claim 58, where the residence time in the mixing chamber is less than about 5 seconds.

75. A method according to claim 58, wherein the removed modified system and optionally also a metal salt solution, is introduced into a crystallizer, the temperature of which is kept in the range of 100-300° C.

76. A method according to claim 58, wherein a reagent selected from the group consisting of a dispersant and a basic compound is present in at least one step of a group consisting of preparing, maintaining, adjusting, crystallizing in said crystallizer, flowing in said plug-flow mode, wherein said dispersant is selected from a group consisting of cationic polymers, anionic polymers, nonionic polymers, surfactants, and mixtures thereof and wherein said method further comprises the step of changing the amount of said dispersant.
